(19) United States
(12) Patent Application Publication
(10) Pub. No.: US 2014/0253617 A1
(43) Pub. Date: Sep. 11, 2014

(54) Device and Method for Spraying Ink

(71) Applicant: Enjet Co., Ltd., Suwon-si, Gyeonggi-do (KR)

(72) Inventor: Su Jung Kim, Seoul (KR)

(21) Appl. No.: 14/352,710

(22) PCT Filed: Oct. 17, 2012
(86) PCT No.: PCT/KR2012/008464

§ 371 Date: Apr. 18, 2014

(30) Foreign Application Priority Data
Oct. 18, 2011 (KR) 1020110106323

(51) Int. Cl. B41J 2/045

(52) U.S. Cl. CPC B41J 2/04576
USPC 347/9

(57) ABSTRACT

Provided herein a device for discharging ink, the device comprising: a nozzle body comprising a chamber for accommodating ink, and a nozzle for discharging the ink to one surface of a target object; an electrode portion attached to or distanced from the nozzle body; a signal generator for applying a voltage to the electrode portion so that electrons may be induced to a liquid surface of the ink and an electrostatic force may be formed, the voltage being lower than a predetermined discharge critical voltage; a nozzle body driver for moving the nozzle body; and a controller for controlling the nozzle body driver to adjust a distance between the nozzle and the one surface of the target object so that an electrostatic force corresponding to the voltage higher than the discharge critical voltage may be formed and thus the ink may be discharged.

### BACKGROUND

1. Field

The following description relates to a device and method for spraying ink, and more particularly, to a device and method for spraying ink through a nozzle.

2. Description of Related Art

Generally, devices for discharging droplets discharge fluid in the form of droplets. Such devices for discharging droplets have been applied to inkjet printers, and they are recently being adapted and developed to be applied to high value product fields such as the display manufacturing process, printed circuit board manufacturing process, and DNA chip manufacturing process.

Ink discharging devices in the inkjet printer field of related art for discharging ink in the form of droplets are mainly piezo driving type and thermal driving type ink discharging devices.

First of all, as illustrated in FIGS. 1 and 2, thermal driving type ink discharging devices comprises a manifold 22 provided in a substrate 10, an ink channel 24 and ink chamber 26 being limited and constrained by a partition 14 formed on an upper portion of the substrate 10, a heater 12 provided inside the ink chamber 26, and a nozzle 16 provided in a nozzle plate 18 and discharging ink droplets 29a.

Such a thermal driving type ink discharging device of related art discharges droplets 29a by means of the following operations.

A supply of a voltage to a heater 12 generates heat, which heats the ink filled inside the ink chamber 26, thereby generating bubbles 28.

Next, the generated bubbles 28 expand, which pressurizes the ink 29 filled inside the ink chamber 26, whereby the ink droplets 29a are discharged outside the nozzle 16 through the nozzle 16.

Next, as the ink is inhaled inside the ink chamber 26 from the manifold 22 through the ink channel 26, the ink chamber 26 is re-charged with the ink 29.

However, in the aforementioned thermal driving type ink discharging device of related art, the heat of the heater 12 for forming bubbles may cause chemical changes in the ink 29. In this regard, there is a disadvantage that a problem such as quality deterioration of the ink 29 may occur.

In addition, significant changes may occur in terms of the volume of the droplets 29a, as they are discharged through the nozzle 16 move towards an object such as a piece of paper. This may lead to a problem such as deterioration of printing quality such as resolution.

Furthermore, such a thermal driving type ink discharging device has limitations in fine controlling of droplets 29a being discharged through the nozzle 16, for example controlling the size and shape of the droplets 29a.

In addition, there is also a problem of the difficulty of embodying a highly integrated ink discharging device due to the aforementioned problems.

Meanwhile, FIGS. 3 and 4 illustrate a different method of a device for discharging ink, that is a device for discharging ink in an electrostatic force method using an electric field.

A device for discharging ink in an electrostatic force method of FIGS. 3 and 4 has a base electrode 32, and an opposite electrode 33 in an opposite location of the base electrode 32. Between the two electrodes 32, 33, ink 31 is injected, and the two electrodes 32, 33 are connected with DC direct current power source 34.

When a voltage is applied to the electrodes 32, 33 by the DC direct current power source 34, an electrostatic field is formed between the two electrodes 32, 33. Accordingly, a Coulomb's Force applies to the ink 31 in the direction of the opposite electrode 33.

Meanwhile, a repulsive force against the Coulomb's Force will also apply to the ink 31 due to its unique surface tension and viscosity and the like, making it difficult for the ink 31 to be easily discharged in the direction of the opposite electrode 33.

Therefore, in order to displace the droplets from the surface of the ink 31 and discharge the droplets, a very high electric field of 1 kV or more must be applied between the electrodes 32, 33.

However, when a high electric field is applied between the electrodes 32, 33, the droplets will be discharged irregularly, locally heating a predetermined portion of the ink 31. That is, the temperature (T1) of the ink 31a located in S1 area will rise above the temperature (T0) of the ink 31 located in another area. Accordingly, the ink 31a in S1 area will expand, whereby electrostatic field will be concentrated on this area, causing numerous electrons to gather

Accordingly, since the repulsive force acting between the electrons and the Coulomb's Force caused by the electrostatic field will apply to the inks 31a in the S1 area, as illustrated in FIG. 4, the droplets will move towards the opposite electrode 33 as they are displaced from the ink 31a in the S1 area.

### SUMMARY

However, in such a device for discharging ink using electrostatic force, ink droplets are discharged irregularly, thereby deteriorating the printing quality. Especially, as much as the size of the nozzle reduced for a fine patterning, electric instability also increases, making it difficult to form a pattern of a uniform size. This becomes a limitation to practical application despite that the ink discharging method of electrostatic force is a technique capable of forming a nano size pattern.

Therefore, the purpose of the present disclosure is to resolve the aforementioned problems of related art, that is to provide a device and method for discharging ink that is capable of discharging ink while satisfying the electric field conditions necessary for discharging of ink by moving a nozzle body while providing a predetermined electrostatic force thereby adjusting the distance between the nozzle and a target object.

In a general aspect, there is provided a device for discharging ink, the device comprising: a nozzle body comprising a chamber for accommodating ink, and a nozzle for discharging the ink to one surface of a target object; an electrode portion attached to or distanced from the nozzle body; a signal generator for applying a voltage to the electrode portion so that electrons may be induced to a liquid surface of the ink and an electrostatic force may be formed, the voltage being lower than a predetermined discharge critical voltage; a nozzle body driver for moving the nozzle body; and a controller for controlling the nozzle body driver to adjust a distance between the nozzle and the one surface of the target object so that an electrostatic force corresponding to a voltage higher than the discharge critical voltage may be formed and thus the ink may be discharged.

In the general aspect of the device for discharging ink, the nozzle body driver may comprise a piezo actuator.

In the general aspect of the device for discharging ink, the nozzle body and the nozzle body driver may be integrated with each other.

In the general aspect of the device for discharging ink, the controller may drive the nozzle body driver in consideration of a timing when the ink should be discharged to adjust the distance between the nozzle and the one surface of the target object to be shorter than a prior distance, so that an electrostatic force corresponding to the voltage higher than the discharge critical voltage may overcome a surface tension of a liquid surface of the ink and thus the ink may be discharged.

In the general aspect of the device for discharging ink, the controller may control movement of the nozzle body driver in vertical direction during horizontal movement of the nozzle body driver with respect to the target object, the controller calculating a movement point in vertical direction of the nozzle body driver based on the timing when the ink should be discharged, so that a vertical movement may be performed in a phased manner.

In the general aspect of the device for discharging ink, the controller may control so that the ink may be in a dot or line form on the one surface of the target object.

In another general aspect, there is provided a method for discharging ink, the method comprising: attaching an electrode portion to a nozzle body or distancing the electrode portion from the nozzle body, the nozzle body comprising a nozzle for discharging ink inside a chamber to one surface of a target object; applying a voltage to the electrode portion by inducing electrons to a liquid surface of the ink so that an electrostatic force may be formed, the voltage being lower than a predetermined discharge critical voltage; and moving the nozzle body to adjust a distance between the nozzle and the one surface of the target object so that an electrostatic force corresponding to a voltage higher than the discharge critical voltage may be formed and thus the ink may be discharged.

In the general aspect of the method for discharging ink, the discharging the ink may involve controlling so that the ink may be in a dot or line form on the one surface of the target object.

According to the present invention of such a configuration, it is possible to apply a voltage that is lower than a predetermined discharge critical voltage so as to form a meniscus by forming an electrostatic force on a liquid surface of ink, and to move the nozzle body to make the distance between the nozzle and one surface of the target object of discharge closer than a prior distance, whereby an increased electrostatic force overcomes a surface tension of the liquid surface of the ink so that the ink may be discharged.

Accordingly, it becomes possible to discharge ink uniformly while applying a lower voltage than in related art.

### BRIEF DESCRIPTION OF THE DRAWINGS

Throughout the drawings and the detailed description, unless otherwise described, the same drawing reference numerals will be understood to refer to the same elements, features, and structures. The relative size and depiction of these elements may be exaggerated for clarity, illustrating, and convenience.

FIGS. 1 and 2 are views for explaining a device of related art for discharging ink in a thermal driving method.

FIGS. 3 and 4 are views for explaining a device of related art for discharging ink in an electrostatic force method.

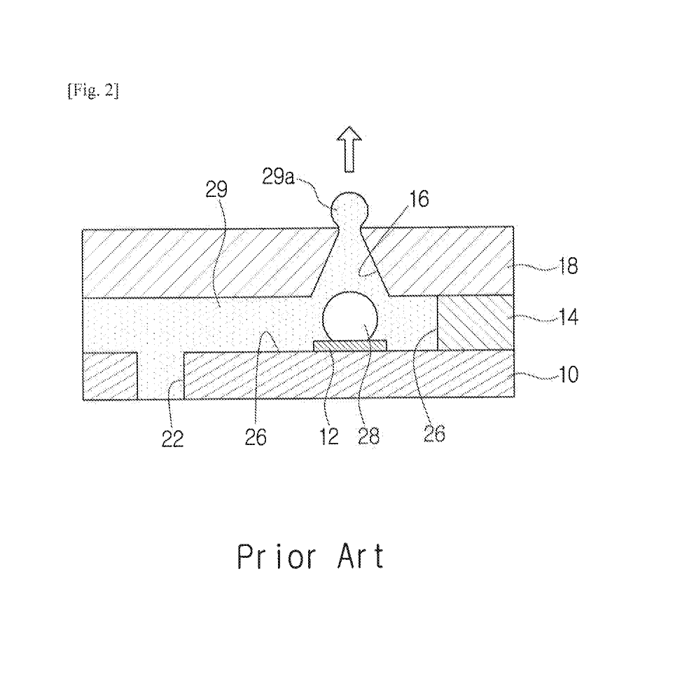

FIG. 5 illustrates a configuration of a device for discharging ink according to an exemplary embodiment of the present disclosure.

FIG. 6 is a graph for explaining a discharge critical voltage in an exemplary embodiment of the present disclosure.

FIG. 7 is a view for explaining a transferring process of a nozzle body according to an exemplary embodiment of the present disclosure.

FIG. 8 is a variation example of an exemplary embodiment of the present disclosure.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

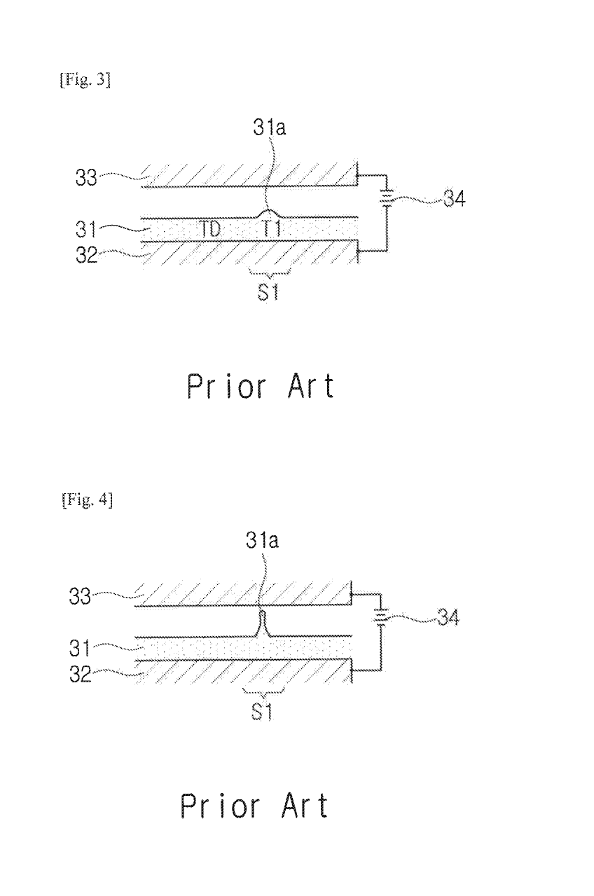

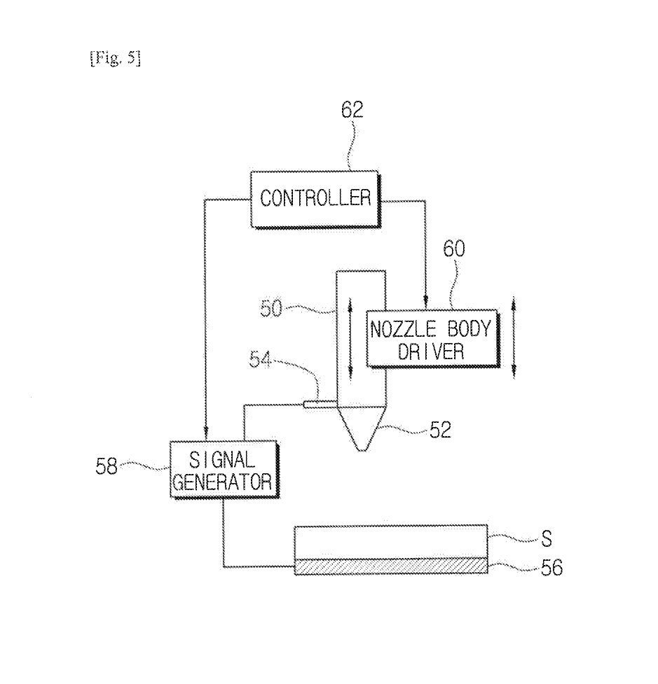

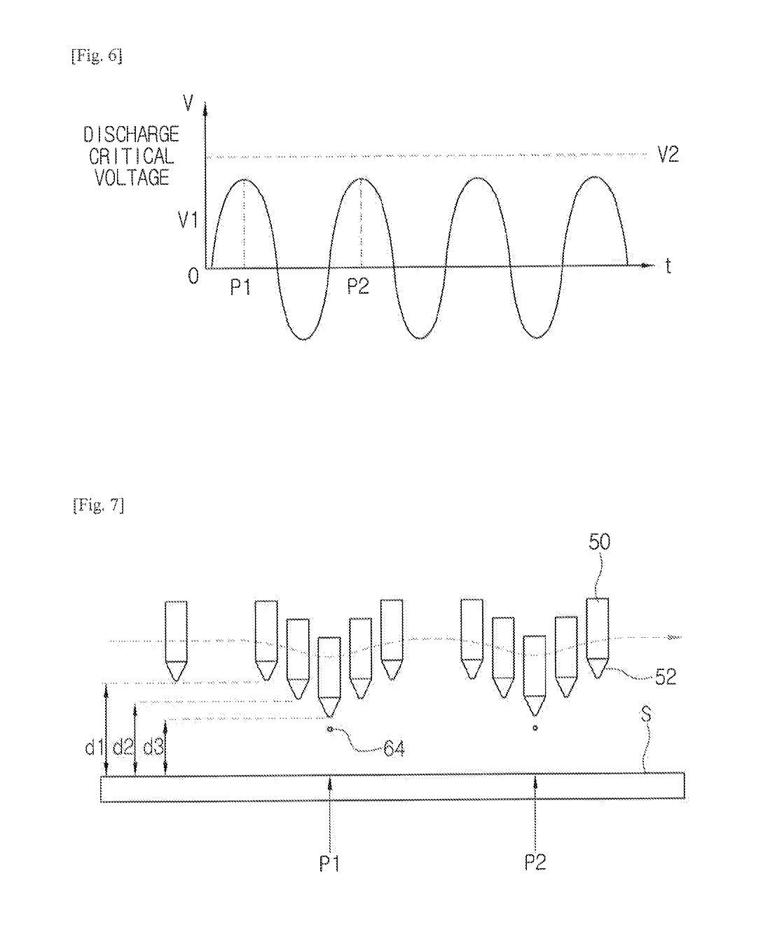

FIG. 5 illustrates a configuration of a device for discharging ink according to an exemplary embodiment of the present disclosure, FIG. 6 is a graph for explaining a discharge critical voltage in an exemplary embodiment of the present disclosure, and FIG. 7 is a view for explaining a transferring process of a nozzle body according to an exemplary embodiment of the present disclosure.

A device for discharging ink according to an exemplary embodiment of the present disclosure comprises a chamber 50, nozzle 52, first electrode 54, second electrode 56, signal generator 58, nozzle body driver 60, and controller 62.

The chamber 50 accommodates ink supplied from outside. The nozzle 52 is formed at one end of the chamber 50 in such a manner that it is in fluid communication with the chamber 50. At a lower end of the nozzle 52, a discharge pore is formed. The ink accommodated in the chamber 50 is discharged through the nozzle 52, the ink being changed to droplets and then discharged towards and hit one surface of a target object of discharge (S; for example, substrate and printing material and the like).

Meanwhile, the nozzle 52 may be made of a conductive material, or of a nonconductive material to which a conductive wire is embedded. By configuring the nozzle with a conductive material or embedding a conductive wire thereto, it is possible to increase the efficiency of the jetting. This is because a current induced by the external electric field can be formed on the conductive material, whereby a stronger electric field can be applied to the ink.

The chamber 50 and nozzle 52 can be regarded as an example of a nozzle body disclosed in the claims of the present disclosure. A nozzle body comprising a chamber 50 and a nozzle 52 may be provided in various shapes. When necessary, it may be provided in various shapes other than those illustrated in FIG. 5.

One end of the first electrode 54 is inserted into the chamber 50 of the nozzle body and contacts ink, while the other end is exposed to an outer surface of the chamber 50. The second electrode 56 is spaced from the first electrode 54. The second electrode 56 is either attached to the other surface of a target object (S) or is spaced therefrom. Preferably, the first electrode 54 and the second electrode 56 are installed such that they are parallel to each other. The aforementioned first electrode 54 and second electrode 56 can be regarded as an example of an electrode portion disclosed in the claims of the present disclosure.

The signal generator 58 applies an alternating current voltage to the first electrode 54 and second electrode 56. When the alternating current voltage is applied to the first electrode 54 and second electrode 56, electrons are induced to the liquid surface of the ink inside the chamber 50. Then, an electrostatic force is formed on the liquid surface by the electrons induced to the liquid surface of the ink.

Generally, when this electrostatic force overcomes a surface tension of the liquid surface, discharging of droplets occurs.

However, in the present exemplary embodiment of the present disclosure, the signal generator 58 outputs an alternating current voltage (V1) that is lower than the predetermined discharge critical voltage (V2) as illustrated in FIG. 6. Herein, the discharge critical voltage (V2) means the voltage at the moment when the aforementioned electrostatic force overcomes the surface tension of the liquid surface. Such a discharge critical voltage (V2) can be easily obtained by a plurality of tests or experiments. This is because, unlike in a device of related art for discharging ink wherein the size of a signal of an alternating voltage is increased and then ink is discharged, in the exemplary embodiment of the present disclosure, the distance of the nozzle and one surface of a target object (S) is adjusted by moving the nozzle body such that the distance is shorter than the prior distance (that is, the distance therebetween in the case where an electrostatic force lower than the discharge critical voltage (V2) is formed by an alternating current voltage (V1)). Whereby the electrostatic force overcomes the surface tension of the liquid surface so as to enable the ink to be discharged. The electrostatic force is inversely proportionate to the distance square, and thus the shorter the distance between the nozzle 52 and one surface of the target object (S), the greater the electrostatic force between the nozzle 52 and the target object (S). In other words, in the present exemplary embodiment, when the signal generator 58 applies an alternating voltage (V1) lower than the predetermined discharge critical voltage (V2) to the first electrode 54 and the second electrode 56, the electrostatic force formed on the liquid surface of the ink cannot overcome the surface tension of the liquid surface, but forms a convex shaped meniscus. Meanwhile, when the nozzle body is moved such that the distance between the nozzle 52 and the target object (S) is shorter than the prior distance, the electrostatic force overcomes the surface tension of the liquid surface, whereby ink can be discharged.

The nozzle body driver 60 moves the nozzle body to adjust the distance between the nozzle 52 and one surface of the target object (S). The nozzle body driver 60 is integrated with the nozzle body. Accordingly the nozzle body driver 60 moves together with the nozzle body. Preferably, the nozzle body driver 60 consists of a piezo actuator.

The controller 62 adjusts the distance between the nozzle 52 and one surface of the target object (S) to be shorter than the prior distance by controlling the nozzle body driver 60.

The controller 62 determines the point where droplets must be discharged as when a positive signal of an alternative current voltage (V1) at the signal generator 58 is at a peak (P1, P2, and the like; see FIG. 6). Accordingly, the controller 62 drives the nozzle body driver 60 at the timing when ink must be discharged and adjusts the distance between the nozzle 52 and one surface of the target object (S) to be shorter than that the prior distance, so that ink can be discharged.

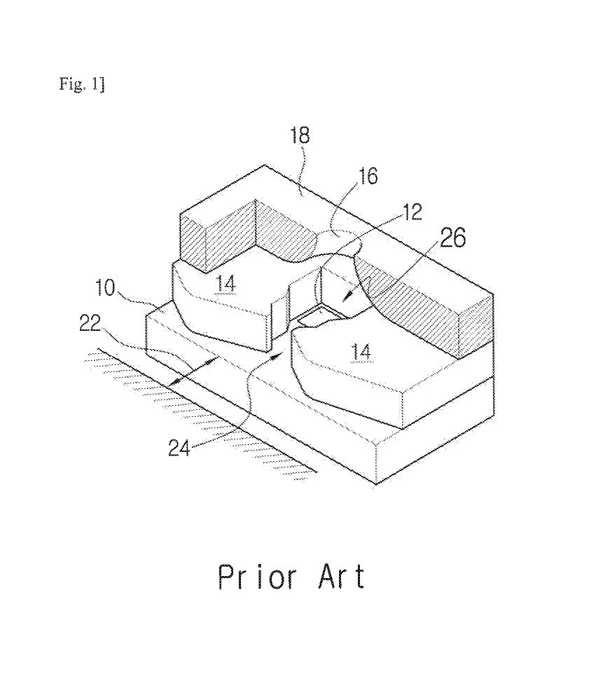

More preferably, as in FIG. 7, the controller 62 controls the phased transferring of the nozzle body driver 60 in a vertical direction while transferring the nozzle body driver 60 in a horizontal direction opposite the target object (S). In other words, when it is a certain time before the timing when the ink should be discharged (P1, P2) while horizontally transferring the nozzle body driver 60 with the distance between the nozzle 52 and one surface of the target object (S) being maintained at “d1”, the nozzle body naturally comes down by the control of the controller 62 until the location where ink can be discharged. With reference to FIG. 1, the distance between the nozzle 52 and one surface of the target object (S) changes in the order of “d1 [symbol] d2 [symbol] d3”. As such, when the distance between the nozzle 52 and the one surface of the target object (S) is “d3”, droplets 64 of ink will be discharged to the one surface of the target object (S). Herein, when the distance between the nozzle 52 and the one surface of the target object (S) is “d1”, it will be appreciated that ink having a convex meniscus is suspending at an end of the nozzle 52. When the distance between the nozzle 52 and the one surface of the target object (S) is “d2”, it will be appreciated that the meniscus at the end of the nozzle 52 is changed into a shape of a Taylor cone. When the distance between the nozzle 52 and the one surface of the target object (S) is “d3”, the Taylor cone is separated and becomes droplets, and discharged to the one surface of the target object (S).

As such, in the present exemplary embodiment, the nozzle body is lowered in a phased manner such that the distance between the nozzle 52 and the one surface of the target object (S) changes in the order of “d1 [symbol] d2 [symbol] d3”, in consideration of the timing when ink must be discharged. In addition, once ink is discharged, the distance between the nozzle 5 and the one surface of the target object (S) adjusted to change in opposite order, that is “d3 [symbol] d2 [symbol] d1”.

In the present exemplary embodiment, the nozzle body is not lowered precisely at the time when ink should be discharged. However, if the nozzle body is to be lowered precisely at the time when ink should be discharged, the nozzle body must stop at a predetermined position and then be lowered, and thus it would be difficult to stop the nozzle body at the predetermined position and some trembling would occur. Accordingly, in the present exemplary embodiment, the nozzle body starts to be lowered before the timing when ink should be discharged, and stops at the timing when ink should be discharged. This is performed by a control algorithm embedded in the controller 62.

As such, when the distance between the nozzle 52 and the one surface of the target object (S) is “d3”, droplets 64 are discharged on the one surface of the target object (S). Referring to FIG. 7, the droplets 64 would seem to be printed in a dot form on the one surface of the target object (S).

In the present exemplary embodiment, it is possible to have droplets to be printed in a line form instead of a dot form. Although not illustrated in the drawings, when printing in a line form, the speed of movement of the nozzle body may affect the thickness of the line. The movement speed of the nozzle body may be controlled by the controller 62.

Next, an operation of a device for discharging ink according to an exemplary embodiment of the present disclosure will be explained in detail.

First, as illustrated in FIG. 5, a first electrode 54 is attached to a nozzle body comprising a chamber 50 and a nozzle 52; and a second electrode 56 is disposed below a target object (S).

Next, a predetermined alternating current voltage is applied to the first electrode 54 and the second electrode 56 by a signal generator 58 so that electrons may be induced to a liquid surface of ink inside the chamber 50 and an electrostatic force is formed. Herein, the alternating current voltage being applied is lower (V1) than the predetermined discharge critical voltage V2 as illustrated in FIG. 6.

Next, the controller 62 comprehends the timing when the ink should be discharged and controls such that the discharging can be made at the right timing. The controller 62 comprehends points “P1” and “P2” as the timing when ink should be discharged as illustrated in FIGS. 6 and 7.

Therefore, before that points arrive, the controller 62 controls the nozzle body driver 60 to lower the nozzle body in a phased manner as illustrated in FIG. 7. Then the nozzle body will be lowered in such a manner than the distance between the nozzle 52 and the target object (S) changes in the order of “d1 [symbol] d2 [symbol] d3”. Accordingly, when the distance between the nozzle 52 and the target object (S) becomes “d3”, droplets 64 are discharged on one surface of the target object (S).

After the droplets 64 are discharged on the one surface of the target object (S), the distance between the nozzle 52 and the one surface of the target object (S) will become “d1” in the opposite order.

Furthermore, subsequent ink discharging timings are comprehended and the aforementioned operation is repeated accordingly.

In the aforementioned operation of the exemplary embodiment of the present disclosure, it was explained that the signal generator 58 outputs an alternating current voltage (V1) that is lower than the predetermined discharge critical voltage (V2), but it is also possible to output a direct current voltage constantly that is lower than the critical value instead of an alternating current voltage. That is, the signal generator 58 applies a certain level of direct current voltage that is lower than the critical value to the first electrode 54 and the second electrode 56, thereby inducing electrons to the liquid surface of the ink inside the chamber 50 so that a predetermined electrostatic force is formed. Herein, the nozzle body driver 60 is controlled in consideration of the timing when the ink should be discharged and the distance between the nozzle 52 and the one surface of the target object (S) is adjusted so that ink can be discharged.

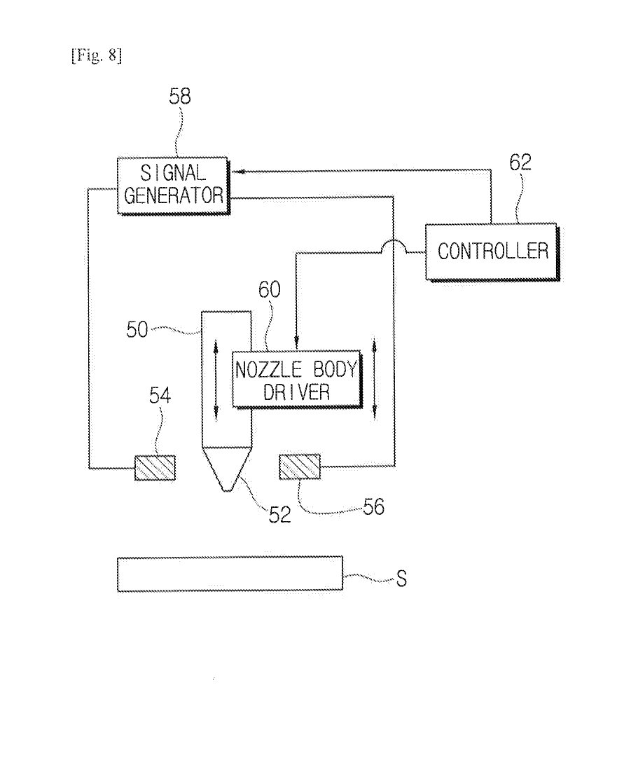

FIG. 8 is a variation example of an exemplary embodiment of the present disclosure. In the present exemplary embodiment, one end of the first electrode 54 is inserted into the chamber 50 to contact the ink, the other end being exposed to the outer surface of the chamber 50, and the second electrode 56 is distanced from the first electrode 54 such that it is attached to the other surface of the target object (S). However, in this variation example, the first electrode 54 is distanced from one side of the nozzle body, and the second electrode 56 is distanced from the other side of the nozzle body.

As such, the rest is the same as in the aforementioned exemplary embodiments except for how the electrode portion is installed. The same operations and effects of the aforementioned exemplary embodiments are obtained from the variation example of FIG. 8 as well.

According, those skilled in the art will fully appreciate the variation example based on the aforementioned exemplary embodiments, and further description of the variation example is omitted.

A number of examples have been described above. Nevertheless, it will be understood that various modifications may be made. For example, suitable results may be achieved if the described techniques are performed in a different order and/or if components in a described system, architecture, device, or circuit are combined in a different matter and/or replaced or supplemented by other components or their equivalents. Accordingly, other implementations are within the scope of the following claims.

### INDUSTRIAL FEASIBILITY

Provided herein is a device and method for discharging ink wherein the nozzle body is moved while providing a predetermined electrostatic force so as to adjust the distance between the nozzle and the target object and satisfy the electric field conditions necessary for discharging the ink.

What is claimed is:

1. A device for discharging ink, the device comprising:
a nozzle body comprising a chamber for accommodating ink, and a nozzle for discharging the ink to one surface of a target object;
an electrode portion attached to or distanced from the nozzle body;
a signal generator for applying a voltage to the electrode portion so that electrons may be induced to a liquid surface of the ink and an electrostatic force may be formed, the voltage being lower than a predetermined discharge critical voltage;
a nozzle body driver for moving the nozzle body; and
a controller for controlling the nozzle body driver to adjust a distance between the nozzle and the one surface of the target object so that an electrostatic force corresponding to a voltage higher than the discharge critical voltage may be formed and thus the ink may be discharged.

2. The device according to claim 1,
wherein the nozzle body driver comprises a piezo actuator.

3. The device according to claim 1,
wherein the nozzle body and the nozzle body driver are integrated with each other.

4. The device according to claim 1,
wherein the controller drives the nozzle body driver in consideration of a timing when the ink should be discharged to adjust the distance between the nozzle and the one surface of the target object to be shorter than a prior distance, so that an electrostatic force corresponding to the voltage higher than the discharge critical voltage may overcome a surface tension of a liquid surface of the ink and thus the ink may be discharged.

5. The device according to claim 1,
wherein the controller controls movement of the nozzle body driver in vertical direction during horizontal movement of the nozzle body driver with respect to the target object, the controller calculating a movement point in vertical direction of the nozzle body driver based on the timing when the ink should be discharged, so that a vertical movement may be performed in a phased manner.

6. The device according to claim 1,
wherein the controller controls so that the ink may be in a dot or line form on the one surface of the target object.

7. A method for discharging ink, the method comprising:
attaching an electrode portion to a nozzle body or distancing the electrode portion from the nozzle body, the nozzle body comprising a nozzle for discharging ink inside a chamber to one surface of a target object;
applying a voltage to the electrode portion by inducing electrons to a liquid surface of the ink so that an electrostatic force may be formed, the voltage being lower than a predetermined discharge critical voltage; and
moving the nozzle body to adjust a distance between the nozzle and the one surface of the target object so that an electrostatic force corresponding to a voltage higher than the discharge critical voltage may be formed and thus the ink may be discharged.

8. The method according to claim 7,
wherein the discharging the ink involves controlling so that the ink may be in a dot or line form on the one surface of the target object.
